(19) United States
(12) Patent Application Publication
(10) Pub. No.: US 2005/0155445 A1
(43) Pub. Date: Jul. 21, 2005

(54) Main housing shifter assembly, front offset, tremec T56 transmission

(76) Inventor: Shafi Keisler, Knoxville, TN (US)

Correspondence Address: Shafi Keisler % Keisler Automotive Engineering, 2216-B W. Gov. John Sevier Hwy., Knoxville, TN, 37920, US

(21) Appl. No.: 10/417,429

(22) Filed: Apr. 16, 2003

(51) Int. Cl. G05G 9/00; B60K 20/00

(52) U.S. Cl. 74/473.1

(57) ABSTRACT

A new design of the “front offset lever” to allow multiple positioning of the shifter assembly on Tremec T-56 transmissions.

### DESCRIPTION OF THE DRAWINGS

FIG. 1 is prior art showing the original shifter position.

FIG. 2 is the section AA is showing the pertinent components of the prior art.

FIG. 3 is the new design showing a typical relocation of shifter position.

FIG. 4 is the section BB is showing the pertinent components of the relocated shifter position.

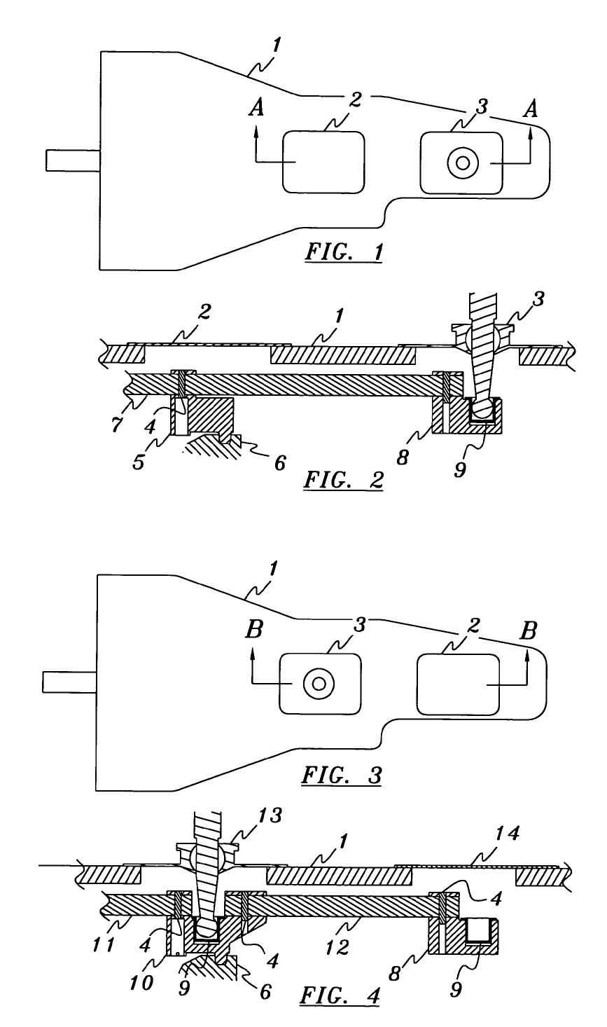

### DETAILED DESCRIPTION OF INVENTION

The invention will be referenced to the accompanying drawing. To understand in full detail, please refer to the accompanying drawing.

The shifter assembly (3) is removed and altered to detail (13).

The cover plate (2) is removed.

The original “front offset lever” (5 as shown in FIG. 2) is removed and replaced by the redesigned front offset lever and shifter socket combination (10 as shown in FIG. 4).

An additional isolator cup (9) is used in the newly designed detail (10).

The original shifter rail (7 as shown in FIG. 2) is replaced with the shorter forward shifter rail (11 as shown in FIG. 4) to allow operational room for the repositioned shifter assembly (3).

A rear shifter rail (12 as shown in FIG. 4) is mounted to provide rigidity and connection with the rear offset lever (8).

Items 8, 10, 11, and 12 are pinned together with roll pins (4 as shown in FIG. 4) to provide an integral assembly.

The altered shifter (13) is assembled to the forward section and couples with the front offset lever combination (10).

The altered shifter assembly (10) allows for transfer of the shifting movements to the internal transmission mechanism (6 as shown in FIG. 4).

A redesigned cover plate (14) is assembled to the rear access port of the transmission.

1. A new design of the “front offset lever” to allow multiple positioning of the shifter assembly.

2. The new design allows for adaptation of standard or alternate shifter assemblies.

3. A relocation of the shifter position to allow adaptation of a 6 speed transmission to a variety of auto platforms.

4. The relocation is effected with no degradation of the transmission.

5. The required movements and distances for shifting are the same as for those in the original position.
